(19) United States
(12) Patent Application Publication
(10) Pub. No.: US 2005/0280227 A1
(43) Pub. Date: Dec. 22, 2005

(54) Storage bin

(75) Inventors: Paul I.J. Murphy, Glen Iris (AU); Stephen B. Lister, Glen Iris (AU)

Correspondence Address: STITES & HARBISON PLLC, 1199 NORTH FAIRFAX STREET, SUITE 900, ALEXANDRIA, VA, 22314, US

(73) Assignee: D & B WHOLESALE PTY LTD.

(21) Appl. No.: 11/152,369

(22) Filed: Jun. 15, 2005

Related U.S. Application Data
(60) Provisional application No. 60/618,187, filed on Oct. 14, 2004.

(30) Foreign Application Priority Data
Jun. 16, 2004 (AU) 2004903280

(51) Int. Cl. B62B 1/00

(52) U.S. Cl. 280/47.31; 224/401

(57) ABSTRACT

There is disclosed a storage bin (11) transportable by a wheelbarrow of the kind comprised of a load receptacle, a front support wheel and a pair of elongate handles spaced one to either side of the load receptacle and projecting rearwardly from the load receptacle, said storage bin (11) having front (18) and rear (19) walls connected by side walls (20) and a floor (21) defining a storage space (22), the side walls (20) being stepped so as to have outwardly extending downwardly facing shoulders (23) extending from front to rear of the bin such that the bin can be mounted on the handles of a wheelbarrow of the said kind so as to straddle the handles with the shoulders of its side walls resting on the handles and the parts (24) of the side walls below the shoulders projecting downwardly between the handles.

### RELATED APPLICATIONS

The present application claims benefit of Australian provisional application no. 2004903280 filed 16 Jun. 2004 and U.S. provisional application No. 60/618,187 filed 14 Oct. 2004.

### FIELD OF THE INVENTION

This invention relates to storage bins and in particular it provides a storage bin which may be readily transported by a wheelbarrow and may be used as a wheelbarrow accessory.

### BACKGROUND TO THE INVENTION

Wheelbarrows are commonly used in gardening and horticultural activities and also on building sites for transporting various materials, for example, garden refuse, sand, soil, bricks and rubble. Generally, a wheelbarrow comprises a load receptacle, a front support wheel and a pair of elongate handles spaced one to each side of the load receptacle and projecting rearwardly from the receptacle. The load receptacle may be of varying size and depth, but the spacing between the handles will generally be very similar and such that they can be readily grasped and lifted by a person standing between them.

Activities requiring the use of a wheelbarrow frequently also require the use of tools of various kinds, or hardware items which may be carried around individually by hand and readily misplaced or lost.

### SUMMARY OF THE INVENTION

The storage bin provided by the present invention may be used to store such tools or hardware items or other articles and to readily transport them on a conventional wheelbarrow.

According to the invention, there is provided a storage bin transportable by a wheelbarrow of the kind comprised of a load receptacle, a front support wheel and a pair of elongate handles spaced one to either side of the load receptacle and projecting rearwardly from the load receptacle, said storage bin having front and rear walls connected by side walls and a floor defining a storage space, the side walls being stepped so as to have outwardly extending downwardly facing shoulders extending from front to rear of the bin such that the bin can be mounted on the handles of a wheelbarrow of the said kind so as to straddle the handles with the shoulders of its side walls resting on the handles and the parts of the side walls below the shoulders projecting downwardly between the handles.

The front and rear walls and floor of the bin may be moulded from a plastics material. The bin may, for example, be moulded as a unitary shell of a strong plastics material such as polypropylene.

Those parts of the side walls below the shoulders may generally be planar.

The width of the lower part of the bin storage space between these parts of the side walls will be less than the width of the upper part of the bin storage space above the shoulders.

Those parts of the side walls below the shoulders may be inclined to one another in the front to rear direction of the bin. More specifically, they may be divergent toward the front wall of the bin so that the lower part of the bin below the shoulders diverges in the rear to front direction.

The rear wall may be generally planar.

The front wall may be curved in the direction between the side walls so as to be outwardly bowed.

The upper rim of the bin may be formed with an outturned peripheral flange.

The peripheral flange may be formed with one more apertures therethrough.

The peripheral flange may be formed with one or more recesses to serve as storage receptacles for small items.

A part of the peripheral flange may be formed with a downturned edge to produce a hook formation which can be hooked over the rim of the load receptacle of a wheelbarrow to enable the bin to be hung from the receptacle rim against a side of the receptacle. The hook formation may be formed at the outer edge of the peripheral flange along the rim of the rear wall of the bin.

The average distance between the lower parts of the side walls below the shoulders may be in the range 345 mm to 385 mm.

The average width of each of the shoulders between the lower parts and the upper parts of the side walls may be in range 350 mm to 390 mm.

The maximum width between the upper parts of the side walls of the bin may be in the range 470 mm to 530 mm and the maximum distance between the front and rear walls may be in the range 170 mm to 250 mm.

### BRIEF DESCRIPTION OF THE DRAWINGS

In order that the invention may be more fully explained, one particular embodiment will be described in detail with reference to the accompanying drawings in which:

FIG. 1 illustrates a bin fitted to a wheelbarrow;

FIG. 2 is a plan view of the bin;

FIG. 3 is a front view of the bin;

FIG. 4 is a side view of the bin;

FIG. 5 is a diagrammatic skeleton view of the bin;

FIG. 6 is a front perspective view of the bin;

FIG. 7 is a front perspective view of a bin or another embodiment; and

FIG. 8 is a rear perspective view of the bin of FIG. 7.

### DESCRIPTION OF THE PREFERRED EMBODIMENT

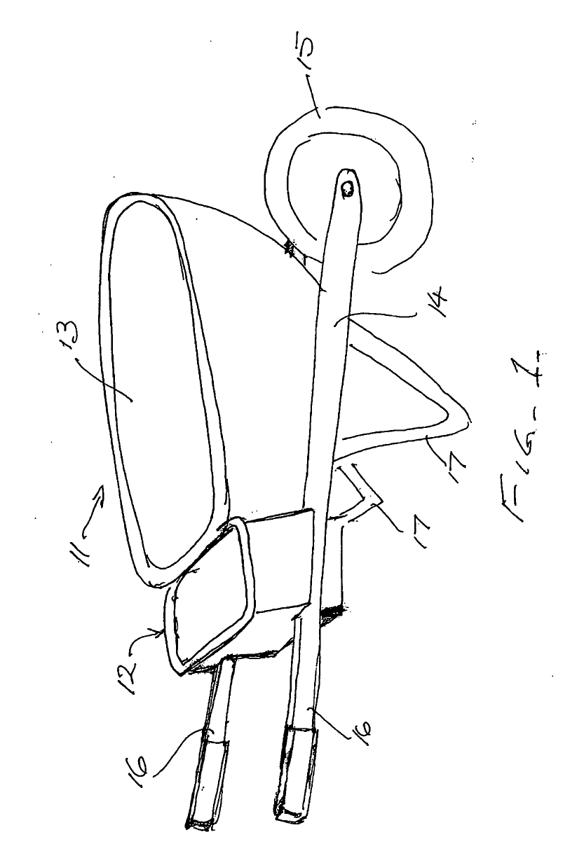

FIG. 1 shows a wheelbarrow 11 fitted with a bin 12 which is constructed in accordance with the present invention. The wheelbarrow is of conventional construction comprising an open topped load receptacle 13 mounted between a pair of long shafts 14 which project forwardly from the receptacle as forks which carry a front support wheel 15 of the barrow. The rear ends of the shafts project rearwardly from the load receptacle as barrow handles 16. A pair of V-shaped barrow legs 17 are fitted to the shafts to support the barrow when it is not being moved.

Storage bin 12 has front and rear walls 18, 19 connected by side walls 20 and a floor 21 forming an open topped storage space 22. Side walls 20 are stepped so as to have outwardly extending downwardly facing shoulders 23 extending from the front to the rear of the bin such that the bin can be mounted on the handles 16 of the barrow so as to straddle the handles with the shoulders 23 resting on the handles. The lower parts 24 of the side walls 20 are generally planar and diverge outwardly from one another in the direction from the rear wall 19 to the front wall 18 so that the lower part of the bin below the shoulders diverges slightly in the rear to front direction to accommodate the normal divergence of the rearwardly projecting handles of a standard wheelbarrow. Each of the lower side wall parts 24 may be inclined from the front to rear direction through an angle in the range 4 to 8 degrees, for example 6 degrees, in order to accommodate the divergence of most wheelbarrow handles.

The width of the lower part of the bin storage space 22 between the lower side wall parts 24 is less than the width of the bin above the shoulders and between the upper parts 25 of the side walls 20. The upper parts of the side walls are planar and may be generally parallel with one another in the front to rear direction but may incline slightly upwardly and outwardly to the upper rim of the bin.

The rear wall 19 is generally planar, whereas the front wall 18 is curved in the direction between the side walls 20 so as to be outwardly bowed. Both the rear wall 19 and the front wall 18 are not quite perpendicular to the floor 21, but are inclined forwardly from the perpendicular through a small acute angle. Moreover, the shoulders 23 are slightly inclined upwardly in the rear to front direction with the result that when the bin is mounted on the barrow handles, it will be slightly tilted when the barrow is rested on the ground, but will be lifted to a generally upright condition when the barrow is being moved.

The upper rim of the bin is formed with an outturned peripheral flange 26. The segment of flange 26 extending along the front wall 18 of the bin is formed with two shallow rectangular recesses 27 which can serve as trays or receptacles for small items such as gloves, hose fittings or small tools. The edges of the side segments of flange 26 extending along the side walls 20 are downwardly curved at 28 to serve as convenient finger holds when the bin is being lifted onto or off the barrow.

The rear segment of peripheral flange 26 extending along rear wall 19 is formed with a downward extension 29 producing a hook formation by which the bin can be hooked over the rim of the load receptacle 13 of the barrow to enable the bin to be hung from the side of that receptacle.

The illustrated bin can be moulded as a unitary shell from a strong plastics material such as polypropylene. This provides a strong lightweight construction. In use, the bin is simply lifted and dropped onto the barrow handles so as to straddle those handles and to rest against the rear of the load receptacle of the barrow. The bin may conveniently be made to an overall width of about 500 to 550 mm, an overall depth of about 160 to 180 mm and an overall front to rear dimension of about 250 to 250 mm. The average between the lower parts 24 of the side walls 20 may fall in the range 345 to 385 mm and the average width of the shoulders 23 may range from 350 to 390 mm. It has been found the dimensions falling in these ranges will enable the bin to be fitted to most commercially available wheelbarrows.

The illustrated bin has been advanced by way of example only and it could be modified considerably. For example, the storage receptacles 27 could be omitted and it is not essential that the bin be provided with an extended peripheral flange in the manner illustrated. The bin may, for some applications be fitted with internal dividers or compartments and it could be fitted with a hinged or removable lid. The precise dimensions and shape of the bin could also be varied.

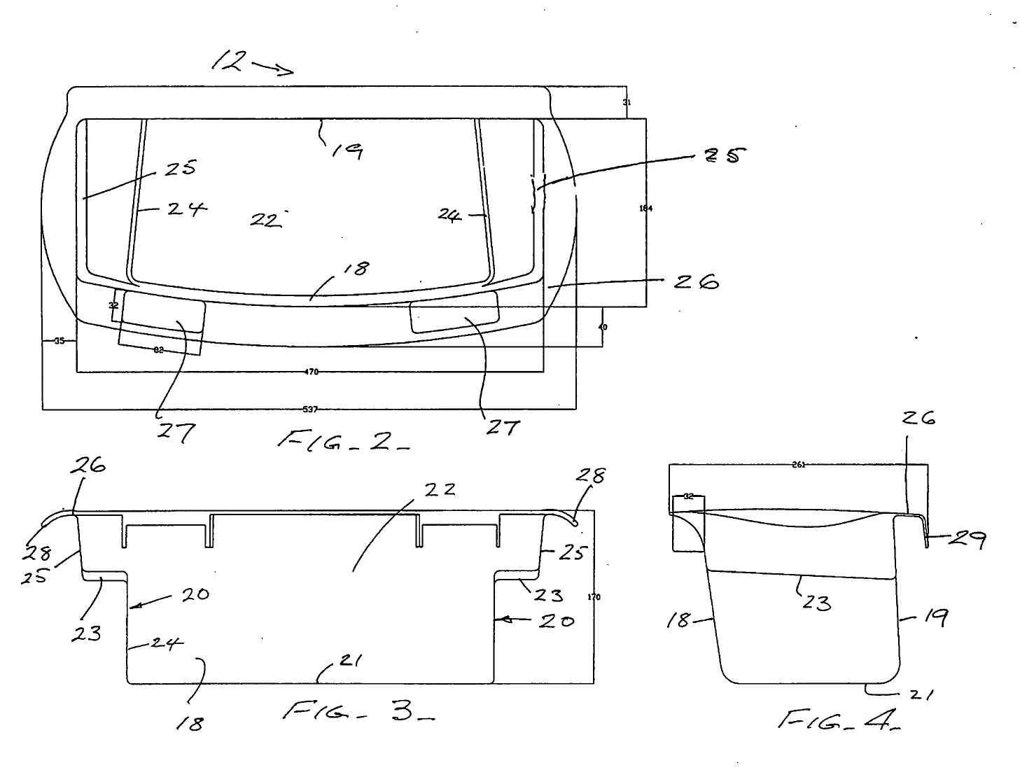

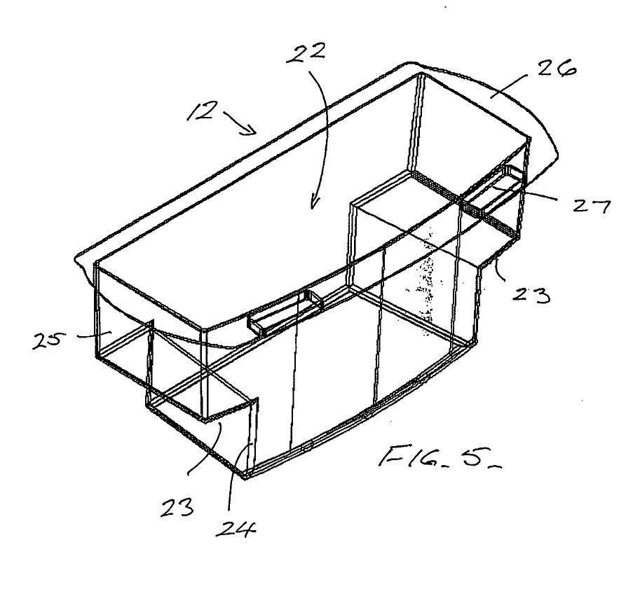

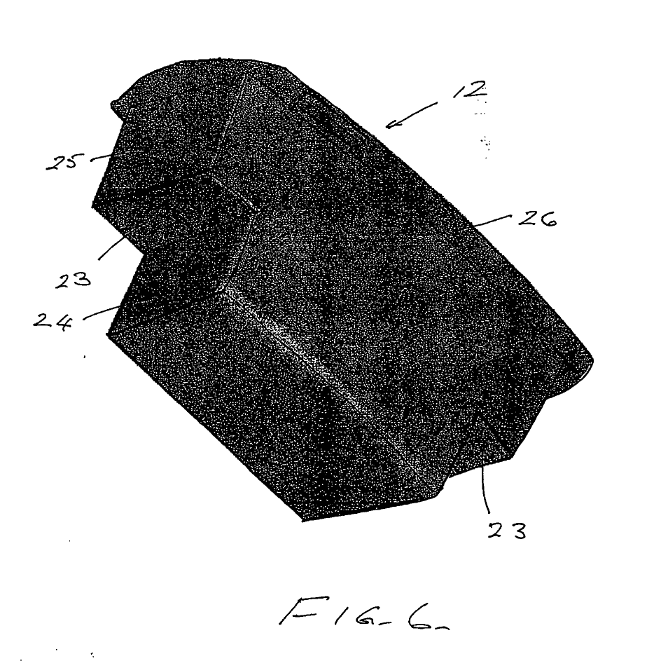

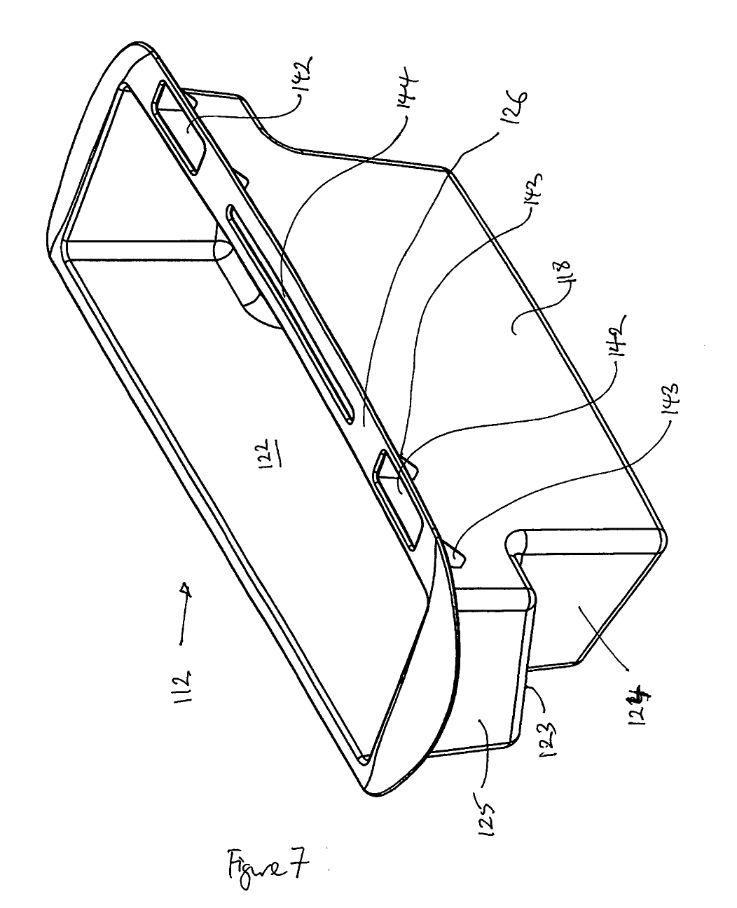

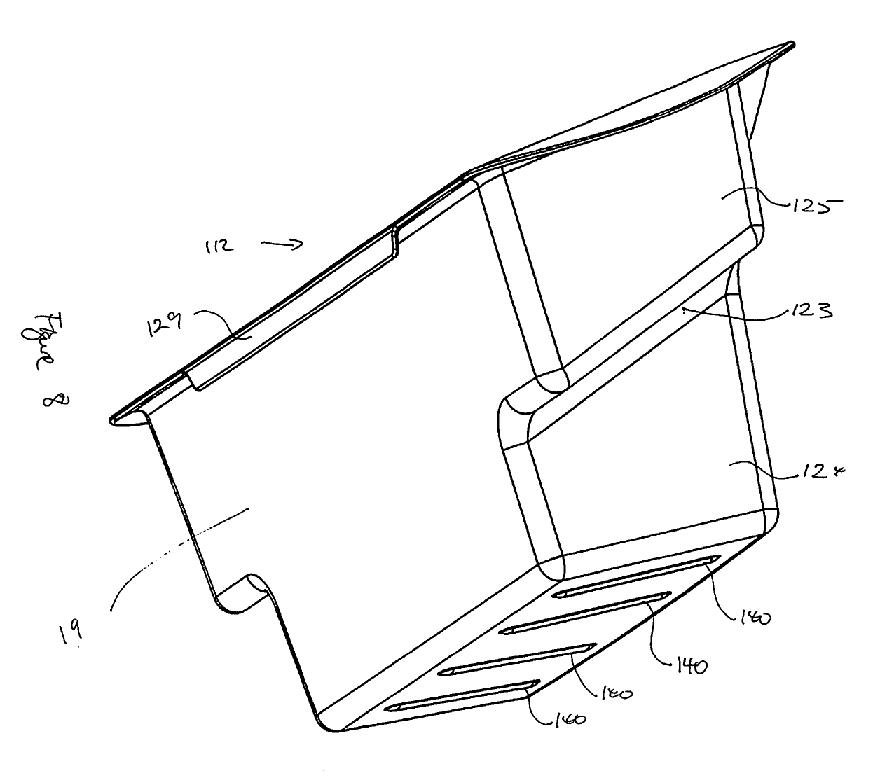

One alternative bin is illustrated in FIGS. 7 and 8. In FIGS. 7 and 8, where features are common to the bins of FIGS. 2 to 6, like numbering is used with the addition of the prefix “1” so that the bin itself for example is labelled as “112” instead of “12”. It will be appreciated that relative to the first embodiment, the bin of FIGS. 7 and 8 has a shoulder 123 with a more pronounced slope and a more graduated curves between the various faces—e.g. between shoulder 123 and lower side portion 124.

The bin also has a plurality of apertures 142,144 and apertures 123 have supporting flanges 143. The apertures are designed to receive part of a small item, such as a tool. For example, a hand trowel can be placed with its handle through aperture 142 and with the blade resting on the peripheral flange 126. Apertures 142,144 can be used for a number of other purposes including as tie on points to tie items to the bin 112.

Referring to FIG. 8, it will also be seen that the bin 112 can incorporate a series of feet 140 to support the bin 112 when the bin 112 is rested on the ground instead of on the wheelbarrow.

It is accordingly to be understood that many variations are possible without departing from the scope of the invention.

1. A storage bin transportable by a wheelbarrow of the kind comprised of a load receptacle, a front support wheel and a pair of elongate handles spaced one to either side of the load receptacle and projecting rearwardly from the load receptacle, said storage bin having front and rear walls connected by side walls and a floor defining a storage space, the side walls being stepped so as to have outwardly extending downwardly facing shoulders extending from front to rear of the bin such that the bin can be mounted on the handles of a wheelbarrow of the said kind so as to straddle the handles with the shoulders of its side walls resting on the handles and the parts of the side walls below the shoulders projecting downwardly between the handles.

2. A storage bin as claimed in claim 1, wherein the parts of the side walls below the shoulders are generally planar.

3. A storage bin as claimed in claim 1, wherein the parts of the side walls below the shoulders are inclined to one another in the front to rear direction of the bin.

4. A storage bin as claimed in claim 1, wherein the parts of the side walls below the shoulders are divergent toward the front wall of the bin so that the lower part of the bin below the shoulders diverges in the rear to front direction.

5. A storage bin as claimed in claim 1, wherein the rear wall is generally planar.

6. A storage bin as claimed in claim 1, wherein the front wall is curved in the direction between the side walls so as to be outwardly bowed.

7. A storage bin as claimed in claim 1, wherein the upper rim of the bin is formed with a peripheral flange.

8. A storage bin as claimed in claim 7, wherein the peripheral flange is formed with one or more recesses to serve as storage receptacles for small items.

9. A storage bin as claimed in claim 7, wherein the peripheral flange is formed with one more apertures.

10. A storage bin as claimed in claim 6, wherein a part of the peripheral flange is formed with a downturned edge to produce a hook formation which can be hooked over the rim of the load receptacle of a wheelbarrow to enable the bin to be hung from the receptacle rim against a side of the receptacle.

11. A storage bin as claimed in claim 10, wherein the hook formation is formed at the outer edge of the peripheral flange along the rim of the rear wall of the bin.

12. A storage bin as claimed in claim 1, wherein the average distance between the lower parts of the side walls below the shoulders is in the range 345 mm to 385 mm.

13. A storage bin as claimed in claim 1, wherein the average width of each of the shoulders between the lower parts and the upper parts of the side walls is in range 350 mm to 390 mm.

15. A storage bin as claimed in claim 1, wherein the maximum width between the upper parts of the side walls of the bin is in the range 470 mm to 530 mm and the maximum distance between the front and rear walls may be in the range 170 mm to 250 mm.
